(19) United States
(12) Patent Application Publication
(10) Pub. No.: US 2009/0290673 A1
(43) Pub. Date: Nov. 26, 2009

(54) Method and device for realizing stable plasma confinement by pressure of AC magnetic field which can be used for controlled nuclear fusion

(76) Inventor: Vladimir Aleksandrovich Svidzinski, Los Alamos, NM (US)

Correspondence Address: Vladimir Svidzinski, 2117 43rd Street, Apt A, Los Alamos, NM, 87544, US

(21) Appl. No.: 12/468,339

(22) Filed: May 19, 2009

Related U.S. Application Data
(60) Provisional application No. 61/054,656, filed on May 20, 2008.

(51) Int. Cl. H05H 1/12; G21B 1/00

(52) U.S. Cl. 376/133; 376/121

(57) ABSTRACT

The invention relates to method and devices for producing stable hot plasma. In particular, the invention can be applied for realizing stable plasma in a thermonuclear reactor to provide energy source for power generation. In the method plasma is confined by pressure of AC magnetic field concentrated in a layer between plasma surface and surrounding conducting shell in which stabilizing feedback on the confined plasma is created by achieving conservation of the AC magnetic flux amplitude. The device for realization of the proposed method comprises a toroidal conducting shell filled with plasma, with AC voltages applied to insulated cuts in the shell made in poloidal and toroidal directions such that said AC magnetic field is created by AC currents in the shell and image currents on the plasma surface. The amplitudes and relative phases of said voltages are rather arbitrary, in particular they can be selected such that the resultant magnetic vector rotates in the plane tangential to the plasma surface with nearly circular polarization exerting nearly time independent magnetic pressure on the plasma.

### CROSS-REFERENCE TO RELATED APPLICATIONS

This application claims the benefit of Provisional Patent Application Ser. No. 61/054,656 filed May 20, 2008.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The present invention relates to the plasma confinement methods in which plasma is insulated from material boundaries by the pressure of oscillating electromagnetic field. The time averaged pressure of electromagnetic field balances plasma pressure preventing plasma from expanding and contacting material boundaries. The electromagnetic field penetrates into plasma on a few skin depths such that most of the plasma volume is approximately field free. This requires that the frequency of the confining field be smaller than the electron plasma frequency, ω<ωₚₑ. The same field confines and heats plasma.

Among such plasma confinement concepts the present invention belongs to a class in which the frequency of the confining field f is in the lower range such that the size of the device b is much smaller than the wave length of electromagnetic wave in vacuum propagating at the same frequency,

$$f ≪ \frac{c}{b} , \qquad ( 1 )$$

where c is the speed of light. This condition distinguishes the present concept from more widely studied concepts known in the art as plasma confinement in resonant cavities which operate at high frequencies such that the wave length of the confining field is comparable with the size of the device. The physics of plasma confinement in the two regimes is different, especially when plasma equilibrium and stability are considered. Due to the condition (1), in the present concept magnetic pressure significantly exceeds the contribution to the pressure from the electric field such that plasma is confined by the pressure of oscillating magnetic field. Because plasma is a good electrical conductor, the component of this magnetic field perpendicular to the plasma surface is approximately zero, and the confining magnetic field is nearly tangential to the plasma surface. Thus the polarization of this field is defined in planes tangential to the plasma surface. AC fields whose frequency satisfies the condition (1) are known in the art as quasistationary fields.

According to the present invention the confining oscillating magnetic field is generated in a layer between the plasma surface and conducting shell surrounding plasma volume with special feedback arrangement between perturbations of plasma boundary and said electromagnetic field such that said feedback produces a stabilizing effect on said plasma boundary. This stabilizing feedback is realized by the condition that the amplitude of oscillating magnetic flux through any section of the volume surrounded by the shell is conserved. Since the AC magnetic field does not penetrate far into the conducting unmagnetized plasma the conservation of the amplitude of magnetic flux constraint fixes magnetic flux amplitudes through sections of the layer between plasma surface and the conducting shell. In order to effectively confine plasma said amplitudes of magnetic fluxes have to be essentially nonzero in different directions in the local planes tangential to the plasma surface. This conservation of magnetic flux amplitude constraint along with the assumption that said amplitudes of magnetic fluxes are nonzero insures that the plasma boundary is in a stable equilibrium with the confining magnetic field. In this case a displacement of the plasma boundary toward the shell results in a local increase of time averaged magnetic pressure and restoration of the plasma equilibrium.

According to the present invention this plasma confinement method is implemented in toroidal device. Plasma is created and confined in toroidal chamber which is bounded by toroidal shell made from an electrically conducting material. AC voltages are applied to narrow insulated cuts in the shell made in poloidal and toroidal directions such that the confining AC magnetic field is created by AC currents in the shell and by image currents on the plasma surface. For the frequencies of interest the toroidal shell can be approximated as a perfect conductor such that path integrals of tangential electric field along any closed path along the shell's surface (considering insulated gaps as part of the shell) are equal to the gain of voltages across said narrow gaps. The amplitudes of these voltages are defined by the amplitudes of AC voltages applied to the gaps. According to Faraday's law of electromagnetic induction, considered for the given frequency, the amplitudes of AC magnetic flux through sections of the volume surrounded by said shell are proportional to the amplitudes of voltages gained at the intersections of said sections with said insulated gaps. When the amplitudes of the voltages applied to the gaps are fixed, the amplitudes of AC magnetic fluxes through these sections are conserved providing the necessary condition for the plasma confinement in this arrangement.

To confine plasma the vectors of AC magnetic field have to be essentially nonzero in different directions in the local planes tangential to the plasma surface. This restricts the amplitudes and relative phases of the voltages applied to the insulated cuts in the toroidal shell. The detailed analysis of the plasma equilibrium and stability in this concept is published by the applicant in Physics of Plasmas, Vol. 14, p. 102512 (2007) and in Plasma Physics and Controlled Fusion, Vol. 50, p. 085017 (2008). The results of this analysis showed that plasma can be maintained in a state of stable equilibrium for a wide range of polarizations of the confining magnetic field in the plane tangential to the plasma surface excluding the case when this polarization is linear. Thus, according to the present invention the amplitudes of the voltages applied to the gaps in the toroidal shell are such that neither one of them is equal to zero.

When magnetic vector of the confining field rotates in the plane tangential to the plasma surface the magnetic pressure on the plasma is time independent and the plasma equilibrium is most quiescent. Thus in the preferred embodiment of the invention the amplitudes and relative phases of the applied voltages are such that the polarization of the confining magnetic field is nearly circular.

For the conducting shell surrounding the plasma volume to play a role of a flux conserver for the amplitude of the confining magnetic field, the currents generating said field have to be driven directly in said shell by the voltages with fixed amplitudes. Such shell plays an active role in plasma confinement, it provides the necessary feedback to stabilize the plasma boundary. Arrangements when the confining AC magnetic field is created by AC currents in external windings are subject of the prior art. In these cases the condition of conservation of the magnetic flux amplitude is not satisfied and there is no plasma equilibrium or stability. In some prior arrangements with the AC magnetic field driven by the external windings a conducting shell surrounding the plasma volume was placed between the plasma and the windings with several cuts made in the shell to allow the AC magnetic flux penetrate inside the volume surrounded by the shell. Such passive shell is not a flux conserver for the confining magnetic field—magnetic flux can flow through the gaps in the shell, such that plasma is not in a stable equilibrium in these cases either. Even closely spaced windings surrounding the plasma volume and generating the confining field can not substitute for the continuous conducting shell because the orthogonal sets of windings in such arrangements are not interconnected electrically with each other and the magnetic flux can flow rather freely through them. Thus the main difference of the present invention with the prior art is that here the confining magnetic field is created by driving AC currents directly in the conducting shell surrounding the plasma volume by applying AC voltages to the narrow insulated gaps in the shell such that the latter acts as a flux conserver for the amplitude of said field.

Plasma confinement concepts of this kind were initially studied with the goal to develop a fusion reactor for electricity generation. First ideas on plasma confinement by the pressure of magnetic field rotating in the plane tangential to the plasma surface at the lower frequencies were formulated in 1950s by J. Berkowitz, H. Grad and H. Rubin in Proceedings of the 2nd United Nations International Conference on the Peaceful Uses of Atomic Energy, Vol. 31, p. 187 (1958), by J. L. Tuck in the same publication, Vol. 32, p. 3 and by M. U. Clauser and E. S. Weibel in the same publication, Vol. 32, p. 161. Also this idea was formulated by D. W. Kerst in U.S. Pat. No. 3,026,447 issued Mar. 20, 1962. It was recognized that when magnetic field has circular polarization in the plane tangential to the plasma surface then the pressure exerted by this field on plasma is time independent, which could result in a quiescent plasma equilibrium.

At that time, however, the importance of how exactly this rotating magnetic field is generated was not recognized. Stability analysis of the plasma boundary supported by the rotating magnetic field was made in the mentioned publication by Berkowitz et. al. (1958). It showed that this boundary is unstable to small perturbations, with the conclusion that this concept is not suitable for plasma confinement. This stability analysis corresponded to the case when the AC magnetic field is created by currents in external windings located far away from the plasma boundary. In the mentioned publication by M. U. Clauser et. al. (1958) and in later works by E. S. Weibel in Physics of Fluids Vol. 3, p. 946 (1960) and by F. Troyon in Physics of Fluids Vol. 10, p. 2660 (1967) it was acknowledged that a conducting shell closely placed to the plasma boundary can stabilize the latter, but it seems that the physics of such stabilization was not completely understood such that the idea of active flux conserving shell was not formulated and plasma confinement arrangement similar to the present invention was not proposed.

Some limited experimental studies of the plasma confinement by rotating magnetic field followed the above theoretical analysis of this concept. These studies were reported by P. C. T. van der Laan and L. H. Th. Rietjens in Nuclear Fusion Supplement Part 2, p. 693 (1962), by I. R. Jones, A. Lietti and J. M. Peiry in Plasma Physics, Vol. 10, p. 213 (1968) and by A. Berney, A. Heym, F. Hofmann and I. R. Jones in Plasma Physics, Vol. 13, p. 611 (1971). In these experiments the conducting shell surrounding the plasma played a passive role. The confining AC magnetic field was at least partially created by external windings and the gaps were made in the shell to allow magnetic flux penetrate inside the chamber. In these configurations the conducting shell is not a flux conserver and its effect on plasma equilibrium and stability is significantly diminished. In these reports the idea of active toroidal flux conserving shell surrounding the plasma volume, which is the subject of the present invention, was not mentioned. Plasma parameters achieved in these experiments were not competitive with the ones achieved in other magnetic confinement concepts such that, to the best of our knowledge, the idea of plasma confinement by rotating magnetic field was abandoned at that time.

Present invention nontrivially modifies the old idea of plasma confinement by rotating magnetic field by introducing a new arrangement in which plasma is in a stable equilibrium with said field, thus making this plasma confinement concept competitive with the other magnetic confinement concepts. Relatively simple design and stability of plasma equilibrium in toroidal devices based on the present idea can result in that such devices will become conventional plasma confinement devices for confining plasmas with a broad range of temperatures and densities, used in numerous plasma applications. This invention can be used in variety of industrial processes, in which the use of the device with stable plasma equilibrium constitutes a pioneering step. These processes include: destroying gaseous toxic waste, processing semiconductors, generating reactive gases, enhancing gaseous chemical processes, etc. These devices can also be used as plasma sources. When operating with high temperature plasmas, these devices can be used as sources of ultraviolet and X-ray radiation (emitted from high Z ions) and as sources of neutrons derived from fusion reactions. One of the applications of this invention is to confine fusion grade plasmas in thermonuclear reactors to provide energy source for power generation. Fusion reactors based on this invention can be designed to have different sizes and power outputs ranging from the smaller ones, used for ships propulsion or to power small cities, to the large gigawatt level reactors.

### BRIEF SUMMARY OF THE INVENTION

The present invention is a plasma confinement device that can be used for creation and confinement of plasma with a wide range of densities and temperatures. In the invention plasma is confined by pressure of oscillating magnetic field concentrated in a layer between plasma surface and conducting shell surrounding the plasma volume with feedback arrangement between perturbations of plasma boundary and said magnetic field such that said feedback produces a stabilizing effect on said plasma boundary. This stabilizing feedback is realized by said shell acting as a flux conserver for the amplitudes of AC magnetic fluxes associated with said AC magnetic field. The frequency of this magnetic field is such that the size of the device is much smaller than the wave length of electromagnetic wave propagating in vacuum with the same frequency. This conservation of magnetic flux amplitudes constraint along with the assumption that the amplitudes of said magnetic fluxes are nonzero in different directions along the plasma boundary insures that the latter is in a state of stable equilibrium with the confining magnetic field. The possibility of stable plasma equilibria in this invention is the main advantage of the present idea when compared with the prior art related to such plasma confinement concepts, meaning that much less power is needed to maintain plasma with particular parameters than in the prior art and also that the previously inaccessible high temperature regimes can now be reached.

According to the present invention this general plasma confinement idea is implemented in toroidal device. Plasma is created and confined in toroidal chamber bounded by toroidal conducting shell. AC voltages are applied to narrow insulated cuts in the shell made in poloidal and toroidal directions such that the confining AC magnetic field is created by AC currents in the shell and by image currents on the plasma surface. When the amplitudes of these voltages are approximately fixed, the amplitudes of AC magnetic fluxes through sections between the plasma surface and the shell are conserved providing the necessary condition for stable plasma equilibrium in this arrangement. In the preferred embodiment of the invention the amplitudes and relative phases of the applied voltages are such that the polarizations of the confining magnetic field in the planes tangential to the plasma surface are nearly circular such that the magnetic pressure on plasma is nearly time independent. Simple design and stability of plasma equilibrium in toroidal devices based on this invention can make them conventional devices for confining plasmas with a broad range of temperatures and densities which can be used in numerous plasma applications.

### BRIEF DESCRIPTION OF THE SEVERAL VIEWS OF THE DRAWINGS

FIG. 1 Proposed device for plasma confinement.

FIG. 2 View of the same device with the device parameters shown for illustration of the physics of plasma confinement.

FIG. 3 Sectional view of the same device taken through the line II-II with modification with a layer of low loss solid dielectric placed along the inner surface of the conducting toroidal shell.

FIG. 4 Sectional view of the same device with modification with a limiter.

FIG. 5 Sectional view of the same device in modification with superconducting toroidal shell.

FIG. 6 Prior art with rotating magnetic field created by combination of currents in external poloidal windings and in toroidal shell.

FIG. 7 Prior art with rotating magnetic field created by currents in orthogonal sets of external windings.

FIG. 8 Prior art with AC magnetic field created by only poloidal currents in toroidal shell.

### DETAILED DESCRIPTION OF THE INVENTION

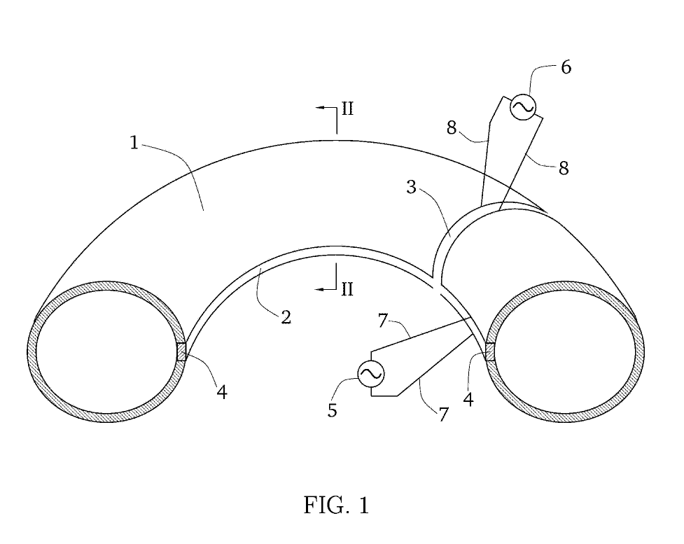

FIG. 1 illustrates the concept of the invention. Plasma is created and confined in toroidal chamber which is bounded by toroidal shell 1 made from an electrically conducting material. There are two narrow cuts in the shell. The first cut 2 is made in substantially horizontal plane (in toroidal direction) and the second cut 3 is made in substantially vertical plane (in poloidal direction). We call these cuts as 2—toroidal gap and 3—poloidal gap. The cuts 2, 3 are sealed with a low loss dielectric material 4 to avoid arcing across the gaps and to maintain the integrity of the chamber. Thus no gas or plasma can pass through the gaps and there is no electrical continuity in the chamber shell 1 both in toroidal and poloidal directions. Initially the plasma chamber is filled with a working gas at some controllable pressure. An optional gas inlet and outlet, not shown in this figure, allow the working gas to flow through the chamber during the discharge. AC voltage sources 5 and 6, generating voltages with the same frequency, are connected across the gaps 2 and 3 via transmission lines (or conducting wires) 7 and 8. For a more uniform application of AC voltages along the gaps, multiple transmission lines (not shown in this figure) originating at sources 5 and 6 and terminating accordingly at different toroidal and poloidal locations along the gaps 2 and 3 can be used. The amplitudes of voltages generated by sources 5 and 6 are both substantially nonzero and the phase difference between these voltages is in general between 0 and 360°. Plasma discharge is created by inductive electric field due to the applied voltages. Plasma is confined by pressure of electromagnetic field concentrated between plasma surface and conducting shell 1. Toroidal shell 1 filled with plasma is a load for external radio-frequency circuit which includes AC generator and which is designed for optimal matching of this circuit with the load. The optimal matching is achieved when frequency of sources 5, 6 is close to natural frequency of oscillations of the combined circuit. Sources 5 and 6 schematically represent supplied voltages from the mentioned external circuit to the mentioned load. The external radio-frequency circuit with the required properties along with the arrangement for uniform application of the supplied voltages along the gaps can be designed by those skilled in the art using common knowledge about the design of such circuits.

The geometry of the device is toroidal in topological sense, it is not limited to the toroidal geometry in exact geometrical sense which has circular sections when cut along either a toroidal or poloidal plane. In general, there can be multiple toroidal and poloidal gaps in the shell 1 placed at different poloidal and toroidal locations. Placing multiple gaps in the shell and applying voltages with the same phases to alike gaps reduces the voltage drop per gap requirement which can be important for confinement of high pressure plasma. The directions and locations of toroidal and poloidal gaps in the shell can be more general than the ones shown in FIG. 1. The gaps can follow rather arbitrary closed paths on the shells surface. The device can operate both in steady-state and in pulsed regime. In the first case the voltage amplitudes are nearly time independent, in the latter case the amplitude has a form of an envelope lasting several periods of oscillations.

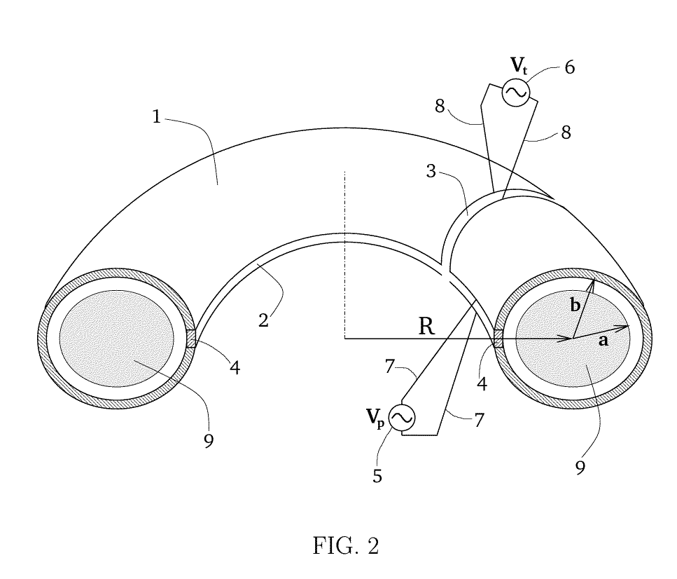

For better illustration of physics of plasma confinement in this concept we introduce the device parameters, shown in FIG. 2. This figure is used primarily for the illustration of the idea. Plasma is confined in toroidal chamber bounded by conducting toroidal shell 1. Narrow toroidal and poloidal cuts in the shell 2 and 3 are sealed with dielectric 4. AC voltage sources 5 and 6, generating voltages with the same frequency, are connected across the gaps 2 and 3 via transmission lines 7 and 8. The major and minor radii of the toroidal chamber are R and b respectively. The radius of plasma 9 is a. AC voltage supplied by the source 5 has amplitude Vₚ and the voltage supplied by the source 6 has amplitude Vₜ. Voltages Vₚ and Vₜ are supplied at the same frequency f and the phase difference between them is Δφ.

In this plasma confinement concept the frequency of confining field f is such that the size of the device b is much smaller than the wave length of electromagnetic wave in vacuum propagating at the same frequency,

$$f ≪ \frac{c}{b} ,$$

where c is the speed of light. Applied voltage Vₚ drives current in the shell 1 substantially in poloidal direction and the image current is driven on the plasma surface (in a skin layer) in opposite direction to prevent electromagnetic field from penetrating the highly conducting plasma. Voltage Vₜ drives current in the shell 1 in substantially toroidal direction and similarly the image current is driven on the plasma surface in the opposite direction. Currents in the shell and image currents on the plasma surface generate electromagnetic field in a layer between plasma surface and the inner surface of the shell 1 at a<r<b, r is coordinate along the minor radius of the torus. This electromagnetic field exerts pressure on the plasma and keeps it from contacting the wall of the shell, thus providing thermal isolation of plasma from material boundaries necessary for effective plasma confinement. In the frequency range defined by the above condition, pressure due to magnetic component of electromagnetic field dominates pressure due to electric field in the layer a<r<b such that plasma is confined by pressure of magnetic field created by oscillating currents in the shell and image currents on the plasma surface driven by the applied voltages Vₚ and Vₜ. At these low frequencies the currents driven by the voltages applied to the gaps are distributed evenly along the toroidal and poloidal directions such that the resultant magnetic field is distributed over the whole volume in the layer between the plasma surface and toroidal shell. If the condition of Eq. (1) is not satisfied then the currents are localized near the gaps resulting in no plasma confinement in this arrangement.

For effective plasma confinement two conditions must be satisfied—plasma has to be in a state of equilibrium with the time averaged pressure of confining field and this equilibrium has to be stable with respect to small perturbations of plasma boundary. One can show that there exist a range of ratios between the amplitudes Vₚ and Vₜ and a range of phase differences Δφ between them for which plasma is in stable equilibrium in the described device. These questions are addressed in details in the mentioned publications by the applicant. This range of suitable operational parameters excludes the limiting cases when one of the amplitudes Vₚ or Vₜ is zero, or when the polarization of the confining magnetic field is linear.

Plasma equilibrium and stability are achieved in this arrangement because the toroidal shell 1 acts like a flux conserver for the amplitude of magnetic flux concentrated in the layer between plasma boundary and said shell, thus providing a stabilizing feedback between perturbations of plasma boundary and said AC magnetic field. According to Faraday's law of electromagnetic induction, considered for the frequency f and assuming that the shell 1 is a perfect conductor, the amplitudes of AC magnetic fluxes through sections of the volume surrounded by the shell 1 are proportional to the amplitudes of voltages gained at the intersections of said sections with the gaps 2,3. When the amplitudes of the voltages Vₚ and Vₜ are fixed, the amplitudes of AC magnetic fluxes through these sections are conserved, they do not depend on the exact shape of the plasma surface. Since the AC magnetic field does not penetrate far into the conducting unmagnetized plasma 9 the conservation of the amplitude of magnetic flux constraint fixes the magnetic flux amplitudes through sections of the layer between plasma surface and the toroidal shell. In this case the magnetic field in said layer acts like an elastic medium such that the time averaged magnetic pressure exerts a restoring force on the plasma boundary when the latter is displaced from its equilibrium, providing the necessary condition for plasma confinement.

As a preferred embodiment of this plasma confinement concept we choose Vₚ, Vₜ and Δφ such that the confining magnetic field is approximately circularly polarized at the plasma surface. In this case magnetic field vectors rotate in the planes tangential to the plasma surface with frequency f. The component of magnetic field normal to the plasma surface is much smaller than the tangential components since plasma is a good conductor. The choice of circularly polarized (or rotating) confining magnetic field is more suitable since in this case magnetic pressure exerted on plasma is nearly time independent resulting in a more quiescent plasma equilibrium. The confining magnetic field has approximately circular polarization at the plasma surface r≈a when

$$\frac{{V}_{t}}{2 π R} = \frac{2 ab ln ( b / a )}{{b}^{2} - {a}^{2}} \frac{{V}_{p}}{2 π b} , Δ φ = \frac{π}{2} , R ≫ b . \qquad ( 2 )$$

In the case when plasma radius a is not very different from radius of the shell b the first condition can be simplified as

$$\frac{{V}_{t}}{2 π R} = \frac{{V}_{p}}{2 π b} . \qquad ( 3 )$$

Thus the preferred embodiment of the considered plasma confinement device is the toroidal device with a relatively large aspect ratio R/b, operating with the applied voltages Vₜ and Vₚ such that their ratio is approximately equal to the aspect ratio of the torus R/b and such that the phase difference between them is 90°.

It should be noted that while the circularly polarized (rotating) magnetic field is the optimal choice for the confining field, other field polarizations can also be used for plasma confinement in this device. Thus the object of this invention is the plasma confinement device described in FIGS. 1,2 with arbitrary values of Vₜ/Vₚ, R/b and Δφ except of the case when either Vₜ or Vₚ is equal to zero.

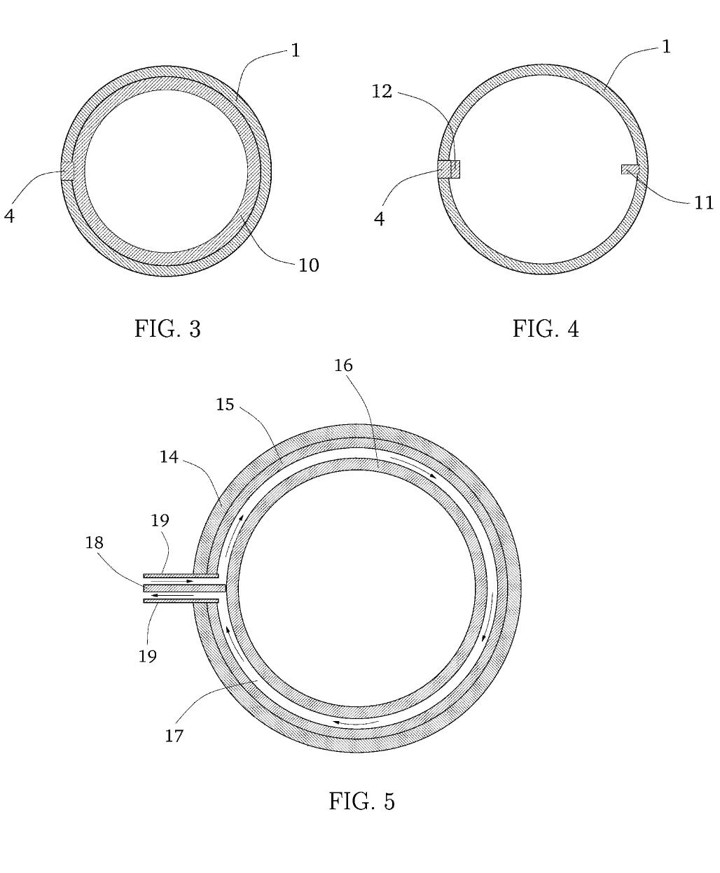

Additional modifications of the described device can be important in practical applications. FIGS. 3, 4, 5 are sectional views of the same device taken through the line II-II in FIG. 1 illustrating these modifications. FIG. 3 shows modification in which a layer of low loss solid dielectric 10 is placed along the inner surface of the conducting toroidal shell 1. This layer can be made from the same or different material as dielectric 4 which seals toroidal and poloidal gaps. The layer of dielectric 10 electrically insulates plasma from the shell 1 preventing arcing in front of the gaps, and the inner surface of this layer approximately defines the plasma radius, thus defining the inductance of the shell filled with plasma providing with the possibility of better matching of the external radio-frequency circuit with the load. Also when the width of the layer between the plasma surface and conducting shell 1 is specified (in this case it is defined by the width of the dielectric layer 10) then the magnetic field amplitude is uniquely defined by the voltages applied to the gaps such that the plasma pressure (which is equal to the magnetic pressure) is an easily controlled parameter. Possible modification of this configuration is such that the dielectric 10 by itself forms the toroidal shell of the chamber while the conducting shell 1 is replaced by a grid (net) of closely spaced inter-connected conducting wires covering outer surface of the dielectric shell 10 with electrical brakes along the positions of toroidal and poloidal gaps to which voltages Vₚ and Vₜ are applied.

FIG. 4 shows modification with a limiter 11 made in a form of a ledge extending in toroidal direction around the inner surface of the shell 1. This limiter limits plasma radius and it can be made from either conducting or dielectric material. A limiter made from dielectric material 12 as an inward extension of dielectric seal 4 can also be used. The limiters 11, 12 can be used separately or simultaneously. Additional limiters can be placed in different locations along the inner poloidal circumference of the chamber. Similarly, limiters can extend in poloidal direction and several of them can be placed in different locations along the inner toroidal circumference of the chamber. A combination of several limiters extended in toroidal direction and several limiters in poloidal direction can also be used. Finally, the limiters can cover smaller lengths in toroidal or poloidal directions (or reduce to a rod pointing inward) instead of extending all the way around the toroidal or poloidal circumferences.

FIG. 5 shows modification with conducting shell 14 made from superconducting material to minimize power loss in the shell due to the AC currents. In this case the system is designed such that the heat generated in plasma is removed by flow of liquid dielectric coolant to minimize heat deposition in the superconductor. In this case a layer of low loss solid dielectric with high thermal conductivity 16 forms a solid plasma facing wall of toroidal chamber. A layer of solid low loss dielectric with low thermal conductivity 15 thermally isolates superconducting shell 14. Additional vacuum layer (not shown in this figure) can be placed between shell 14 and dielectric layer 15 for a better thermal isolation of the shell 14. A flow of liquid dielectric 17 is arranged in cavity between dielectrics 15 and 16 to remove heat deposited in plasma facing layer 16. Plate 18 made from low loss dielectric and plates 19 made from low loss dielectric with low thermal conductivity are used to direct the flow of the liquid dielectric 17, to thermally isolate the superconducting shell 14 and to make electrical break at the toroidal gap. Additional vacuum layer (not shown in this figure) can be placed between shell 14 and plates 19 for a better thermal isolation of the shell 14. In this arrangement the flow of dielectric coolant is introduced through the toroidal gap in the shell 14. In a similar way this flow can be introduced through the poloidal gap, through multiple gaps in the shell or using separate arrangements. There is a separate cooling system (not shown in this figure) for superconducting shell 14 used to maintain the shell in superconducting state. This system can be designed by using common knowledge about the design of such systems.

The use of superconducting shell is required for confinement of high pressure plasma when Ohmic losses in the shell made from ordinary conductor make this plasma confinement concept impractical. Important application of high pressure plasma confinement in this concept is confinement of fusion-grade plasma which may provide useful power from fusion reactions to generate electricity. In this case plasma is created and confined at such density and temperature that fusion reactions

D+T→He⁴(3.5 MeV)+n(14.1 MeV),

D+He³→He⁴(3.6 MeV)+p(14.7 MeV),

D+D→T(1.01 MeV)+p(3.02 MeV),

D+D→He³(0.82 MeV)+n(2.45 MeV)

can be used to generate useful power. The concept of removing heat from plasma by flow of liquid dielectric, illustrated in FIG. 5, can be used in fusion reactor based on the presented plasma confinement device. In general the flow of liquid dielectric can be introduced through the toroidal or poloidal gaps in the torus or through manifolds connected in other places.

In the preceding description different embodiments of the invention are described along with reference to possible modifications thereof. It will be evident that such modifications can be used independently or in a combination with other modifications described above without departing from the scope of the invention.

For the toroidal conducting shell surrounding the plasma volume to play a role of a flux conserver for the amplitude of the confining magnetic field, the currents generating the said field have to be driven directly in said shell by the AC voltages with fixed amplitudes applied to the narrow insulated cuts in the shell. Arrangements when the confining AC magnetic fields are, at least partially, created by AC currents in external windings are subject of the prior art. In these cases the condition of conservation of the magnetic flux amplitude is not satisfied and there is no plasma equilibrium or stability.

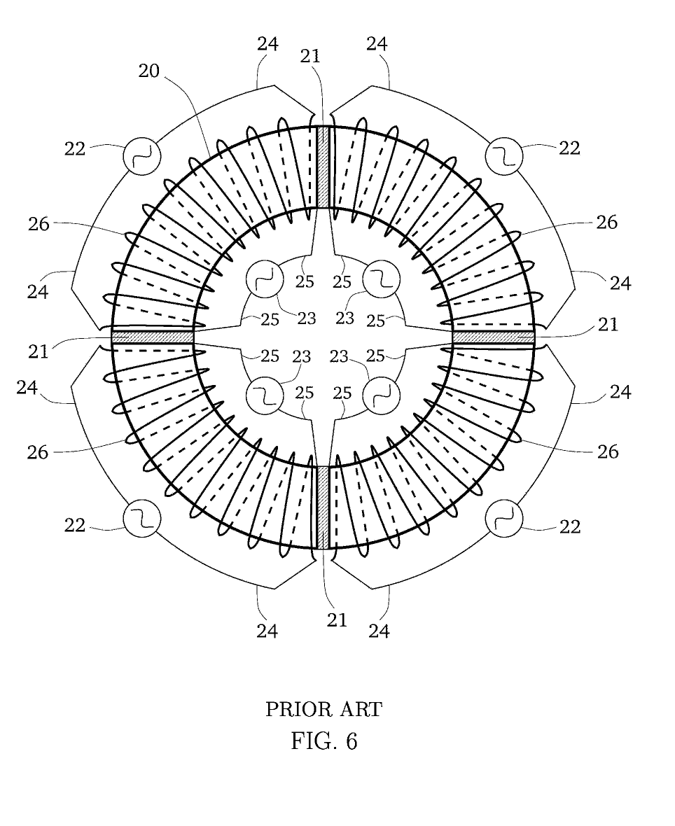

FIG. 6 illustrates conceptually the prior art of D. W. Kerst, U.S. Pat. No. 3,026,447 issued Mar. 20, 1962 in which the rotating magnetic field is created by combination of currents in external poloidal windings and in toroidal shell. Plasma is confined in toroidal chamber 20. Several poloidal cuts sealed with dielectric layers 21 are made in the chamber. Sources of alternating current 22 are connected to multiple helical coils 26 via transmission lines 24. These coils generate toroidal AC magnetic field in the chamber. Sources of alternating current 23 are connected directly to tubular segments of toroidal shell via transmission lines 25. The currents in the shell driven by these sources and the image currents in plasma generate poloidal AC magnetic field in the chamber. The phase difference between sources 22 and 23 is 90° such that the resultant magnetic vector rotates in the chamber providing a continual inwardly directed pressure on the plasma. In this arrangement the toroidal component of the amplitude of AC magnetic flux in the chamber is not conserved (the flux depends on the position of the plasma boundary) and plasma equilibrium is unstable to perturbations which are symmetric in the poloidal direction and non symmetric in the toroidal direction. The amplitude of AC current in helical coils 26 does not depend on toroidal angle (it is the same everywhere along the coils) such that the resultant magnetic pressure due to this current can not adjust for perturbations of plasma boundary varying in toroidal direction. Without additional stabilization these perturbations are unstable, such that there is no plasma confinement in this case. Also an insulated toroidal cut in the shell 20 is not introduced in this arrangement such that it is not clear how the magnetic field generated by coils 26 penetrates inside the chamber.

The main difference of the present invention with the prior art in FIG. 6 is that now the toroidal component of AC magnetic field is created by driving poloidal currents directly in the shell by applying the AC voltage with fixed amplitude directly to the insulated toroidal cut in the shell. Now poloidal currents in the shell in different toroidal locations are independent from each other such that they can independently adjust themselves to perturbations of plasma boundary and stabilize the latter. This stabilization is a direct consequence of the conservation of magnetic flux amplitude constraint introduced in the present invention. The present invention is a nonobvious modification of the prior art. Generation of rotating magnetic field by simultaneously applying two different AC voltages directly to the toroidal and poloidal cuts in the conducting shell is a nontrivial idea which makes all the difference for stability of plasma equilibrium in this plasma confinement concept. One should also note that closely spaced poloidal and toroidal windings surrounding the plasma volume and generating the confining field can not substitute for the continuous conducting toroidal shell because the orthogonal sets of windings in such arrangements are not interconnected electrically with each other and the currents in the windings can not adjust for an arbitrary perturbation of the plasma boundary to completely stabilize the latter. Thus the continuity of surface, carrying currents generating the confining magnetic field, is the necessary condition for plasma confinement in this method.

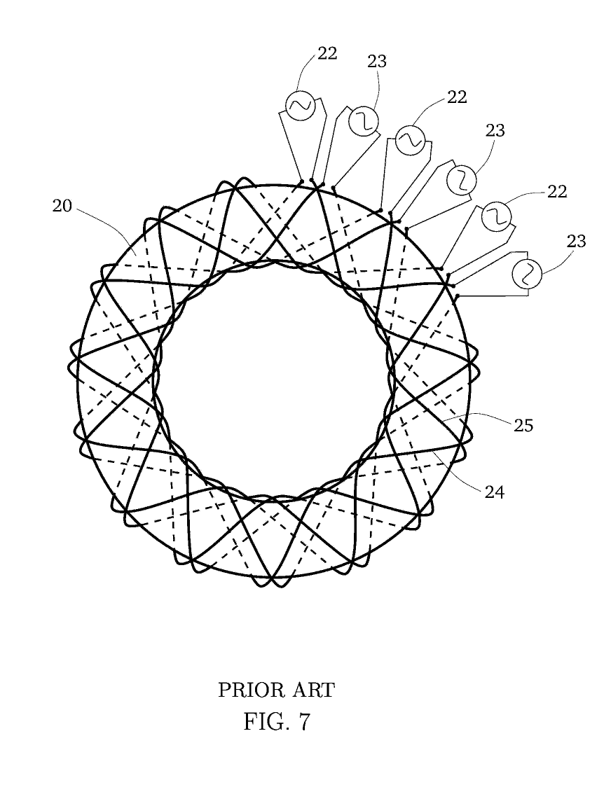

FIG. 7 illustrates conceptually the prior art of P. C. T. van der Laan and L. H. Th. Rietjens published in Nuclear Fusion Supplement Part 2, p. 693 (1962) in which the rotating magnetic field is created by currents in orthogonal sets of external windings. Plasma is confined inside electrically conducting toroidal chamber 20 having several poloidal and toroidal electrical breaks (not shown here) to allow for magnetic flux penetration through the chamber boundary. Sets of helical coils 24,25 with opposite pitch are wound around the toroidal shell 20. The coils with opposite pitches are connected to AC generators 22,23 operating at the same frequency and having 90° phase difference between them. The coils generate rotating magnetic field inside the chamber. In this arrangement the amplitudes of both poloidal and toroidal magnetic fluxes inside the chamber are not conserved (magnetic fluxes can move freely through the electrical breaks in the shell) such that neither plasma equilibrium or stability are realized in this system.

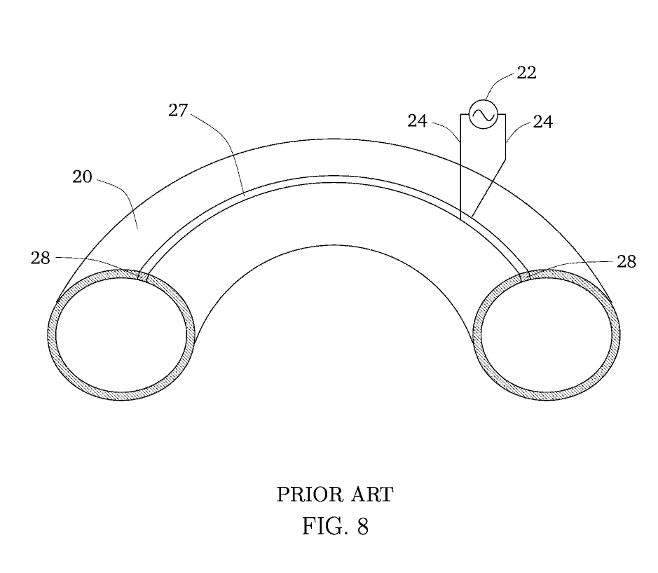

FIG. 8 illustrates conceptually the prior art of A. A. Brailove, U.S. Pat. No. 6,855,906 issued Feb. 15, 2005 in which the AC magnetic field is created by only poloidal currents in the toroidal shell. Plasma is created in toroidal chamber 20 made from an electrically conductive material. Toroidal cut 27, sealed with dielectric layer 28, is made in the chamber. AC power source 22 is connected across the cut 27 via transmission line 24. Poloidal current in the shell, driven by the source 22, generate toroidal AC magnetic field in the chamber. While the amplitude of AC magnetic flux is conserved inside the chamber 20, generating only one component of magnetic field (the confining field with linear polarization) is not enough for plasma confinement. There is no plasma equilibrium in this arrangement—plasma volume moves in the outboard direction until it touches the wall of the chamber. In the present invention both poloidal and toroidal components of AC magnetic field amplitude are generated simultaneously inside the flux conserving chamber, which is the necessary condition for plasma equilibrium and stability in this concept. The limiting cases when either Vₜ or Vₚ is zero in FIG. 2 are excluded from the claimed modes of operation of the proposed device.

Stable plasma equilibrium in the proposed devices along with their relatively simple design can make them conventional plasma confinement devices for confining plasmas with a broad range of temperatures and densities, used in numerous plasma applications. These devices can be used in variety of industrial processes such as destroying gaseous toxic waste, processing semiconductors, generating reactive gases, enhancing gaseous chemical processes, etc. When operating with high temperature plasmas, these devices can be used as extreme ultraviolet and X-ray sources, emitted from high Z ions and as sources of neutrons and protons derived from fusion reactions. One of the applications of this invention is to confine high pressure fusion grade plasmas in thermonuclear reactors to provide energy source for power generation. Fusion reactors based on this invention can be designed to have different sizes and different power outputs ranging from megawatt to gigawatt level reactors.

In the preceding description the invention is described with reference to specific embodiments thereof. It will be evident that various modifications and changes may be made thereto without departing from the broader spirit and scope of the invention as set forth in the claims. The specification and drawings are, accordingly, to be regarded in an illustrative rather than a restrictive sense.

What is claimed is:

1. A method of plasma creation and stable confinement by pressure of AC electric and magnetic fields, with the frequency of said fields such that the size of the confined plasma is substantially smaller than the wave length of electromagnetic wave propagating in vacuum with the same frequency, with polarization of said magnetic field being different from linear, with special feedback arrangement between perturbations of plasma boundary and said electromagnetic field such that said feedback produces a stabilizing effect on said plasma boundary.

2. The method as claimed in claim 1, in which said feedback is realized by means of approximate conservation of amplitude of AC magnetic flux localized in a layer between boundary of said plasma and wall of confining chamber.

3. The method as claimed in claim 1, in which said feedback is realized by generating said AC magnetic field by means of driving AC currents directly in conducting shell surrounding plasma volume.

4. The method in claim 1 used in application selected from the group of: destroying gaseous toxic waste, processing semiconductors, generating reactive gases, enhancing gaseous chemical processes, plasma sources, generating optical, ultraviolet and X-ray radiation, generating neutrons derived from fusion reactions, conducting nuclear fusion reactions, confining fusion grade plasmas in thermonuclear reactors to provide energy source for power generation.

5. A method of producing and confining plasma in which an electric discharge is generated in a gaseous working medium inside a chamber by subjecting said medium to the action of electromagnetic oscillations, with wall of said chamber having a generally toroidal topology, said toroidal topology defining a torus with a hole, a cyclic toroidal direction encircling said hole, and a cyclic poloidal direction generally orthogonal to said toroidal direction, with the frequency of said oscillations such that the minor radius of said chamber is substantially smaller than the wave length of electromagnetic wave propagating in vacuum with the same frequency, with amplitudes of AC magnetic field in said electromagnetic oscillations having nonzero components in the poloidal and toroidal directions inside said chamber in the vicinity of said wall, with said AC magnetic field generated by AC currents driven in said wall of said chamber and by image currents in said plasma.

6. A device for producing and confining plasma comprising:
a. a toroidal chamber adapted for receiving working gasses and for containing said plasma,
b. a chamber wall in a form of a shell having a generally toroidal topology, said toroidal topology defining a torus with a hole, a cyclic toroidal direction encircling said hole, and a cyclic poloidal direction generally orthogonal to said toroidal direction, said shell made from an electrically conducting material, with two narrow cuts in said shell made in substantially toroidal and poloidal directions and sealed with a dielectric material such that no gas or plasma can pass through said cuts and there is no electrical continuity of said shell in toroidal and poloidal directions,
c. AC power sources, generating voltages with the same frequency and nonzero amplitudes, with said power sources connected across said toroidal and poloidal cuts in said shell via transmission lines,
whereby plasma discharge is created by inductive electric field induced by AC magnetic field, said AC power sources drive toroidal and poloidal AC currents in said shell and corresponding image currents in said plasma, with said currents generating AC magnetic field inside said chamber which exerts pressure on said plasma and confines the latter.

7. A device as claimed in claim 6, with arrangement for uniform application of AC voltages, supplied by said AC power sources, along said toroidal and poloidal cuts in said shell.

8. A device as claimed in claim 6, with arrangement for uniform application of AC voltages, supplied by said AC power sources, along said toroidal and poloidal cuts in said shell comprising multiple transmission lines originating at said AC power sources and terminating accordingly at different toroidal and poloidal locations along said cuts in said shell.

9. A device as claimed in claim 6, in which said toroidal shell with said chamber filled with said plasma is a part of a radio-frequency circuit, with said circuit including an AC generator, with said AC power sources supplying voltages to said cuts in said shell schematically representing parts of said radio-frequency circuit.

10. A device as claimed in claim 9, in which the frequency of said AC generator is close to natural frequency of oscillations of said radio-frequency circuit.

11. A device as claimed in claim 6, in which multiple toroidal and poloidal cuts are made in said shell at different poloidal and toroidal locations, said cuts are sealed with a dielectric material, with AC voltages of nonzero amplitudes applied across said cuts.

12. A device as claimed in claim 6, with said AC power sources operating in a regime selected from the group of: a steady-state regime with nearly time independent amplitudes of said voltages, a pulsed mode with the amplitudes of said voltages forming an envelope lasting several periods of oscillations.

13. A device as claimed in claim 6, with said AC power sources supplying generally periodic voltages to said cuts in said shell.

14. A device as claimed in claim 6, with said AC power sources supplying voltages to said poloidal and toroidal cuts in said shell with the ratio of said voltages approximately equal to the ratio of major and minor radii of said toroidal chamber with 90° phase difference between said voltages.

15. A device as claimed in claim 6, with said AC power sources supplying arbitrary nonzero voltages to said poloidal and toroidal cuts in said shell with arbitrary phase difference between said voltages.

16. A device as claimed in claim 6, in which a layer of solid dielectric is placed along the inner surface of said toroidal shell, with said dielectric layer covering all inner surface area of said shell.

17. A device as claimed in claim 16, in which said layer of solid dielectric serves as a wall of said chamber, with said conducting shell replaced by a grid of closely spaced inter-connected conducting wires covering the outer surface of said dielectric layer, with electrical brakes made in said grid of wires along the positions of said toroidal and poloidal cuts to which the AC voltages, supplied by said AC power sources, are applied.

18. A device as claimed in claim 6, with a limiter limiting the radius of said plasma, with said limiter made from either conducting or dielectric material in a form of one or several ledges extending in toroidal or poloidal directions along the inner surface of said shell.

19. A device as claimed in claim 6, in which said toroidal shell is made from superconducting material with additional arrangement designed to remove heat generated in said plasma comprising:
a. a layer of low loss solid dielectric with high thermal conductivity which forms a plasma facing wall of said toroidal chamber,
b. a layer of low loss solid dielectric with low thermal conductivity placed along the inner surface of said superconducting shell and used for thermal isolation of said shell,
c. a layer of liquid dielectric flowing in the cavity between said dielectric layers, with said liquid dielectric used as a coolant to remove heat deposited in said plasma facing dielectric layer,
d. means to introduce the flow of said liquid dielectric coolant.

20. A device as claimed in claim 19, in which said flow of said liquid dielectric coolant is introduced through said toroidal or poloidal cuts in said shell or through manifolds connected in other places.

21. A device as claimed in claim 19, in which said plasma is created and confined at such density and temperature that fusion reactions are used to provide energy source for power generation.
